(19) United States
(12) Patent Application Publication
(10) Pub. No.: US 2003/0038548 A1
(43) Pub. Date: Feb. 27, 2003

(54) Double stage engine cooling module suspension

(76) Inventor: Sylvain Nadeau, London (CA)

Correspondence Address: Siemens Corporation, Intellectual Property Department, 186 Wood Avenue South, Iselin, NJ, 08830, US

(21) Appl. No.: 09/933,204

(22) Filed: Aug. 20, 2001

(51) Int. Cl. H02K 5/24

(52) U.S. Cl. 310/51

(57) ABSTRACT

An engine cooling assembly 10 includes an electric motor 12, a fan 14 driven by the electric motor, and a shroud 16 at least partially surrounding the fan. First, resilient decoupling structure 20 mounts the motor to the shroud in a manner to isolate vibration between the motor and the shroud. Second, flexible decoupling structure 22 is associated with the shroud and is constructed and arranged to mount the shroud to the shroud mounting structure in a manner to isolate vibration between the shroud and the shroud mounting structure when the shroud is coupled to the shroud mounting structure.

### FIELD OF THE INVENTION

The invention generally relates to the reduction of electric motor structure-borne noise in engine cooling applications and, more particularly, to an effective means of isolating the motor's vibration from the rest of the vehicle to reduce in-vehicle structure-borne noise.

### BACKGROUND OF THE INVENTION

In typical engine cooling modules, a DC electric motor is employed to drive a fan. The magnets of the electric motor are subjected to many fluctuating forces. These fluctuating forces generate vibration in the motor housing that can be transmitted to other components and thus, generate noise. Electric motor structure-borne noise is an important contributor to in-vehicle noise, vibration and sound quality in various conditions such as during wind-down or when a pulse-width modulation is used for motor speed control.

Accordingly, there is a need to provide decoupling structure to reduce the motor structure-borne noise in engine cooling applications.

### SUMMARY OF THE INVENTION

An object of the invention is to fulfill the need referred to above. In accordance with the principles of the present invention, this objective is achieved by providing an engine cooling assembly including an electric motor, a fan driven by the electric motor, and a shroud at least partially surrounding the fan. First, resilient decoupling structure mounts the motor to the shroud in a manner to isolate vibration between the motor and the shroud. Second, flexible decoupling structure is associated with the shroud and is constructed and arranged to mount the shroud to the shroud mounting structure in a manner to isolate vibration between the shroud and the shroud mounting structure, when the shroud is coupled to the shroud mounting structure.

In accordance with another aspect of the invention, a method of mounting an electric motor to a shroud and mounting the shroud to a shroud mounting structure includes, providing first, resilient decoupling structure mounting the motor to the shroud in a manner to isolate vibration between the motor and the shroud. Second, flexible decoupling structure mounts the shroud to the shroud mounting structure in a manner to isolate vibration between the shroud and the shroud mounting structure.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is front view of an engine cooling assembly having first decoupling structure mounting a motor to a shroud and second decoupling structure mounting the shroud to a shroud mounting structure, in accordance with the invention.

FIG. 2 is a cross-sectional view of first decoupling structure taken along the line 2-2 in FIG. 1.

FIG. 3 is a cross-sectional view of second decoupling structure taken along the line 3-3 in FIG. 1.

FIG. 4 is a graph of sound pressure level during wind-down comparing the prior art with the structure of the invention.

### DETAILED DESCRIPTION OF THE PREFERRED EMBODIMENT

With reference to FIG. 1, an engine cooling assembly is shown, generally indicated at 10, in accordance with the principles of the present invention. The assembly 10 includes an electric motor 12 that drives a fan 14. A shroud 16 at least partially surrounds the fan in the conventional manner. In the illustrated embodiment, the shroud 16 includes support structure 18 to which the motor 12 is mounted. First, resilient decoupling structure 20 mounts the motor 12 to shroud 16 in a manner to isolate vibration between the motor 12 and the shroud 16. In the illustrated embodiment, the decoupling structure 20 includes a plurality of mounts having at least a portion disposed between the motor 12 and the support structure 18 of the shroud 16. The mounts can be made of an elastomer such as rubber, can be springs or other flexible material to provide a resilient decoupling between the motor 12 and the shroud 16.

As shown in FIG. 2, a preferred embodiment of the first decoupling structure 20 includes a generally cylindrical rubber grommet 21 which receives a portion of an end cap 25 of the motor 12. A portion 23 of the grommet 21 is disposed between the end cap 25 and the support structure 18 of the shroud 16. A fastener 27 passes through a sleeve 29 disposed through the end cap 25 and grommet 21. The fastener 27 is threaded into the support structure 18 to secure the grommet 21 to the support structure 18.

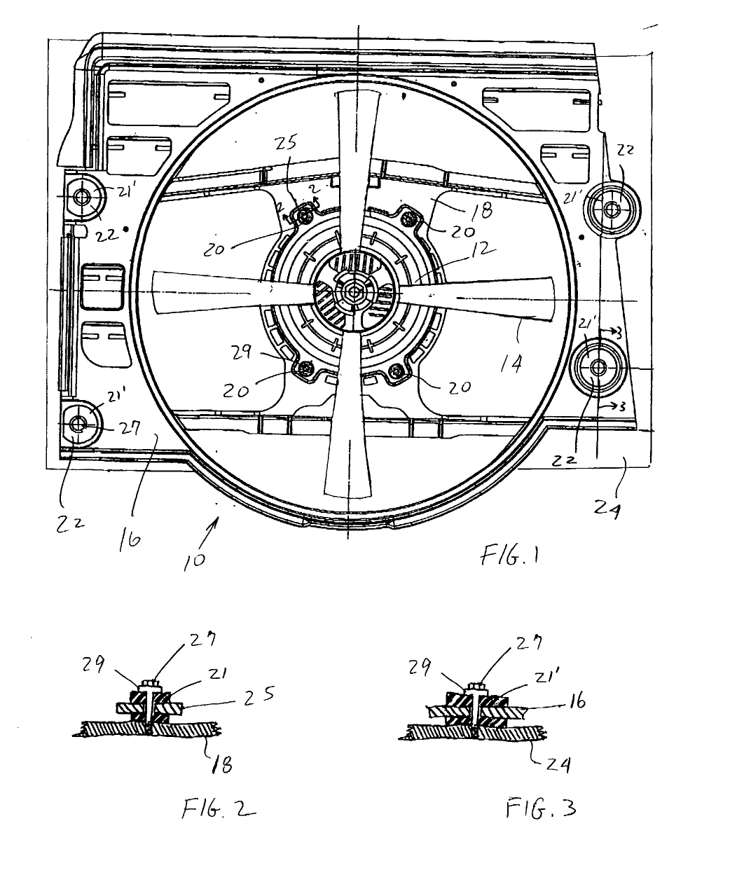

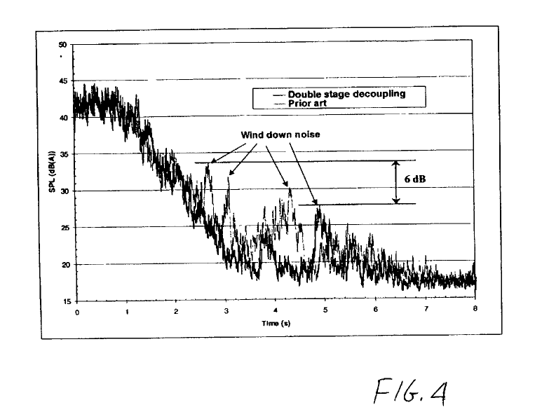

Second, flexible decoupling structure 22 is provided on the shroud 16 and is constructed and arranged to mount the shroud 16 to the shroud mounting structure 24 in a manner to isolate vibration between the shroud 16 and the shroud mounting structure 24, when the shroud is coupled to the shroud mounting structure 24. As shown in FIG. 1, the shroud mounting structure 24 is a frame disposed behind the shroud 16 and fixed within an engine compartment. The shroud mounting structure 24 can be a radiator, a condenser or other under-hood component. In the illustrated embodiment, the second decoupling structure 22 includes a plurality of mounts in the form of grommets 21′ having at least a portion provided between the shroud 16 and the shroud mounting structure 24. Thus, the second decoupling structure 22 is configured substantially identically as the first decoupling structure, but is larger than each first decoupling structure 20. As shown in FIG. 3, a portion of the shroud 16 is received by the grommet 21′ and each grommet 21′ is secured to the shroud support structure 24 via a fastener 27. A portion 23′ of the grommet 21′ is disposed between the shroud 16 and the shroud mounting structure 24.

As shown in FIG. 4, a 6 dB wind-down noise reduction is achieved with the decoupling structure of the invention as compared to a mount where decoupling was used between a frame and a shroud, but a rigid coupling was used between the motor and the shroud.

In designing engine cooling module suspensions, a goal is to create the lowest frequency suspension. However, the highest naturally frequency of the suspension should be limited to √2 times the frequency of excitation of interest. Thus, the highest natural frequency in a suspension using the decoupling structure of the invention should preferably be not more than √2 times the frequency of excitation of interest.

Since there is no rigid connection between the motor 12 and the shroud 16 or between the shroud 16 and the shroud mounting structure 24, motor structure-borne noise in an engine cooling application is reduced.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An engine cooling assembly comprising:
an electric motor,
a fan driven by the electric motor,
a shroud at least partially surrounding the fan,
first, resilient decoupling structure mounting the motor to the shroud in a manner to isolate between the motor and the shroud, and
second, flexible decoupling structure associated with the shroud and constructed and arranged to mount the shroud to the shroud mounting structure in a manner to isolate vibration between the shroud and the shroud mounting structure, when the shroud is mounted to the shroud mounting structure.

2. The assembly of claim 1, wherein the shroud includes support structure, the motor being mounted to the support structure with at least a portion of the first decoupling structure being provided between the support structure and the motor.

3. The assembly of claim 2, wherein the first decoupling structure includes a plurality of mounts.

4. The assembly of claim 3, wherein each mount includes an elastomeric grommet receiving a portion of the motor and secured to the support structure via a fastener.

5. The assembly of claim 1, wherein the second decoupling structure includes a plurality of mounts.

6. The assembly of claim 5, wherein each mount includes an elastomeric grommet receiving a portion of the shroud.

7. The assembly of claim 1, in combination with the shroud mounting structure, with at least a portion of the second decoupling structure being provided between the shroud and the shroud mounting structure.

8. An engine cooling assembly comprising:
an electric motor,
a fan driven by the electric motor,
a shroud at least partially surrounding the fan,
first, resilient means for mounting the motor to the shroud in a manner to isolate vibration between the motor and the shroud, and
second, flexible means for mounting the shroud to the shroud mounting structure in a manner to isolate vibration between the shroud and the shroud mounting structure, when the shroud is coupled to the shroud mounting structure.

9. The assembly of claim 8, wherein the shroud includes support structure, the motor being mounted to the support structure with at least a portion of the first means for mounting being provided between the support structure and the motor.

10. The assembly of claim 9, wherein the first means for mounting includes a plurality of mounts.

11. The assembly of claim 10, wherein each mount includes an elastomeric grommet receiving a portion of the motor and secured to the support structure via a fastener.

12. The assembly of claim 8, wherein the second means for mounting includes a plurality of mounts.

13. The assembly of claim 12, wherein each mount includes an elastomeric grommet receiving a portion of the shroud.

14. The assembly of claim 8, in combination with the shroud mounting structure, with at least a portion of the second means for mounting being provided between the shroud and the shroud mounting structure.

15. An engine cooling assembly comprising:
an electric motor,
a fan driven by the electric motor,
a shroud at least partially surrounding the fan,
first, elastomeric decoupling structure mounting the motor to the shroud in a manner to isolate vibration between the motor and the shroud, and
second, elastomeric decoupling structure associated with the shroud and constructed and arranged to mount the shroud to the shroud mounting structure in a manner to isolate vibration between the shroud and the shroud mounting structure, when the shroud is mounted to the shroud mounting structure.

16. The assembly of claim 15, wherein said first elastomeric decoupling structure includes a plurality of grommets receiving a portion of the shroud.

17. The assembly of claim 15, wherein said second elastomeric decoupling structure includes a plurality of grommets receiving a portion of the shroud.

18. A method of mounting an electric motor to a shroud and the shroud to a shroud mounting structure, the method including
providing a first, resilient decoupling structure mounting the motor to the shroud in a manner to isolate vibration between the motor and the shroud, and
providing a second, flexible decoupling structure mounting the shroud to the shroud mounting structure in a manner to isolate vibration between the shroud and the shroud mounting structure.
